(19) United States
(12) Patent Application Publication
(10) Pub. No.: US 2026/0194845 A1
(43) Pub. Date: Jul. 9, 2026

(54) BELT TRANSPORT DEVICE, FIXING DEVICE, AND IMAGE FORMING APPARATUS

(71) Applicant: FUJIFILM Business Innovation Corp., Tokyo (JP)

(72) Inventors: Kotaro ARAKI, Kanagawa (JP); Takashi OHASHI, Kanagawa (JP); Shogo KAMIYA, Kanagawa (JP); Shingo AKIYAMA, Kanagawa (JP)

(73) Assignee: FUJIFILM Business Innovation Corp., Tokyo (JP)

(21) Appl. No.: 19/298,127

(22) Filed: Aug. 12, 2025

(30) Foreign Application Priority Data
Jan. 7, 2025 (JP) 2025-002426

(51) Int. Cl. G03G 15/20

(52) U.S. Cl. CPC G03G 15/2025; G03G 15/2064; G03G 2215/2038; G03G 2215/2093

(57) ABSTRACT

A belt transport device includes a first rotator; an endless belt that is formed with a nip portion in contact with the first rotator and that transports an object to be transported by the first rotator while rotationally moving; a pressing member that is provided on an inner peripheral side of the belt and that forms the nip portion by pressing the belt against the first rotator from the inner peripheral side; one or more second rotators that are provided on the inner peripheral side of the belt and that stretch the belt together with the pressing member; and plural contact members that are provided on the inner peripheral side of the belt, that are disposed side by side in a rotational movement direction of the belt between the pressing member and the second rotator or between two of the second rotators, and that come into contact with an inner peripheral surface of the belt in a state of being supported by a support that supports the pressing member and the second rotator in different manners.

### CROSS-REFERENCE TO RELATED APPLICATIONS

This application is based on and claims priority under 35 USC 119 from Japanese Patent Application No. 2025-002426 filed Jan. 7, 2025.

### BACKGROUND

### (i) Technical Field

The present disclosure relates to a belt transport device, a fixing device, and an image forming apparatus.

### (ii) Related Art

JP2017-167316A discloses a fixing device including a supply member that supplies a lubricant to an inner surface of a strip-shaped body of a heating member, a removal member that removes the lubricant from the inner surface of the strip-shaped body, and a moving means that moves a facing member between a first position where an unfixed image is fixed and a second position where a contact pressure is reduced, in which the supply member comes into contact with the strip-shaped body and the removal member is separated from the strip-shaped body in conjunction with movement to the first position, and the supply member is separated from the strip-shaped body and the removal member comes into contact with the strip-shaped body in conjunction with movement to the second position.

### SUMMARY

Aspects of non-limiting embodiments of the present disclosure relate to a belt transport device, a fixing device, and an image forming apparatus that can stabilize a contact state of a contact member that comes into contact with a belt as compared with a case where all contact members come into contact with the belt in the same manner.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a belt transport device including: a first rotator; an endless belt that is formed with a nip portion in contact with the first rotator and that transports an object to be transported by the first rotator while rotationally moving; a pressing member that is provided on an inner peripheral side of the belt and that forms the nip portion by pressing the belt against the first rotator from the inner peripheral side; one or more second rotators that are provided on the inner peripheral side of the belt and that stretch the belt together with the pressing member; and a plurality of contact members that are provided on the inner peripheral side of the belt, that are disposed side by side in a rotational movement direction of the belt between the pressing member and the second rotator or between two of the second rotators, and that come into contact with an inner peripheral surface of the belt in a state of being supported by a support that supports the pressing member and the second rotator in different manners.

### BRIEF DESCRIPTION OF THE DRAWINGS

Exemplary embodiment(s) of the present invention will be described in detail based on the following figures, wherein:

FIG. 1 is a configuration diagram showing an image forming apparatus provided with a fixing device including a liquid coating device according to a first exemplary embodiment;

FIG. 2 is a cross-sectional view showing a fixing device including the liquid coating device according to the first exemplary embodiment;

FIG. 3 is a cross-sectional view showing the liquid coating device according to the first exemplary embodiment; and

FIG. 4 is a cross-sectional view showing a fixing device including a liquid coating device according to a second exemplary embodiment.

### DETAILED DESCRIPTION

Hereinafter, an exemplary embodiment (hereinafter, referred to as the present exemplary embodiment) for carrying out the present invention will be described. In the following description, a direction denoted by an arrow X in the drawing will be referred to as an apparatus width direction and a direction denoted by an arrow Y will be referred to as an apparatus height direction. In addition, a direction (a direction along an arrow Z) orthogonal to the apparatus width direction and the apparatus height direction will be referred to as an apparatus depth direction.

### First Exemplary Embodiment

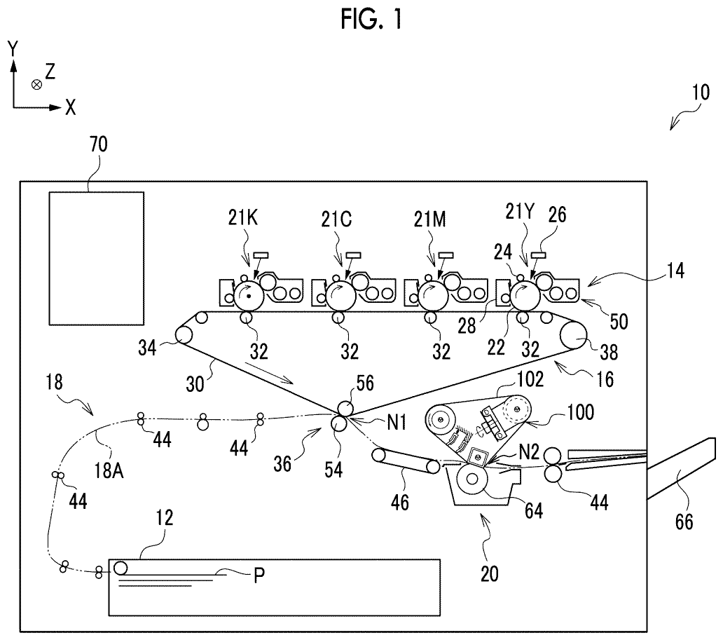

FIG. 1 shows an example of an image forming apparatus 10 in which a fixing device 20 having a liquid coating device of a first exemplary embodiment is disposed. First, an image forming apparatus (see FIG. 1) of the present exemplary embodiment will be described. Next, the fixing device 20 having the liquid coating device according to the first exemplary embodiment will be described.

### Overall Configuration of Image Forming Apparatus

As shown in FIG. 1, the image forming apparatus 10 is an electrophotographic apparatus configured to include a recording medium accommodation portion 12, a toner image forming unit 14, a transfer device 16, a recording medium transport device 18, a fixing device 20, and a control unit 70.

The recording medium accommodation portion 12 has a function of accommodating the paper P as an example of the recording medium before an image is formed.

The toner image forming unit 14 has a function of forming, through a charging step, an exposure step, and a development step, a toner image that is held by an intermediate transfer belt 30 (which will be described later) constituting the transfer device 16. The toner image forming unit 14 includes single-color units 21Y, 21M, 21C, and 21K that form a toner image on each photoreceptor 22 using toners of different colors (Y (yellow), M (magenta), C (cyan), and K (black)), as an example. In addition, the toner image forming unit 14 is able to form a toner image configured with a plurality of colors, for example, in accordance with image data. The photoreceptor 22 is an example of an image carrier.

The single-color units 21Y, 21M, 21C, and 21K have the same configuration as each other except for colors of toner images formed by the respective single-color units. Hereinafter, in a case where it is not necessary to distinguish the single-color units 21Y, 21M, 21C, and 21K and the components thereof, the alphabets (Y, M, C, and K) of the single-color units 21Y, 21M, 21C, and 21K will be omitted in the description. Each single-color unit 21 is configured to include a photoreceptor 22, a charging device 24, an exposing device 26, a developing device 50, and a cleaning device 28.

The transfer device 16 has a function of holding the toner images of the respective colors formed by the respective single-color units 21 and transferring the toner images to the paper P. The transfer device 16 includes an intermediate transfer belt 30, four transfer rolls 32, a drive roll 38, a secondary transfer unit 36, and a tension roll 34. The intermediate transfer belt 30 has an endless shape. The four transfer rolls 32 and the respective photoreceptors 22 form nips with the intermediate transfer belt 30 interposed therebetween. The intermediate transfer belt 30 rotationally moves in a direction along an arrow by the drive roll 38. In the present exemplary embodiment, as an example, the single-color units 21Y, 21M, 21C, and 21K are disposed in this order from the upstream side to the downstream side in the rotational movement direction of the intermediate transfer belt 30. As a result, the toner image on the photoreceptor 22 formed by the single-color units 21Y, 21M, 21C, and 21K is superimposed and transferred to the intermediate transfer belt 30 by the transfer roll 32.

The secondary transfer unit 36 includes a transfer roll 54 that comes into contact with a surface of the intermediate transfer belt 30 on which a toner image is held, and a facing roll 56 that is disposed to face the transfer roll 54 with the intermediate transfer belt 30 interposed therebetween. In the secondary transfer unit 36, the toner images of the respective colors held by the intermediate transfer belt 30 are transferred to the transported paper P. Here, the toner image forming unit 14 is an example of a developing device in the present disclosure.

The recording medium transport device 18 has a function of transporting the paper P such that the paper P passes through a nip N1 of the secondary transfer unit 36 and a nip N2 of the fixing device 20. The recording medium transport device 18 includes a plurality of transport rolls 44 and a transport belt 46. Here, the transport rolls 44 and the transport belt 46 are an example of a transport means. The transport rolls 44 are configured with a pair of rolls disposed in a contact state. The transport rolls 44 transport the paper P accommodated in the recording medium accommodation portion 12 along a transport path 18A.

The transport belt 46 has a configuration in which an endless belt is wound around a pair of rolls disposed to be separated from each other. The transport belt 46 is disposed downstream of the secondary transfer unit 36 and upstream of the fixing device 20 in a transport direction of the paper P. The transport belt 46 is configured to transport the paper P on which the toner images are transferred by the secondary transfer unit 36 to the fixing device 20 along the transport path 18A.

The control unit 70 has a function of controlling each unit of the image forming apparatus 10. For example, the control unit 70 controls each unit of the image forming apparatus 10 (that is, causes each unit to perform each operation) in accordance with job data received from an external device (not shown). Here, the job data includes the image data (image information) used to cause each single-color unit 21 to form the toner image and data necessary for other image forming operations.

The fixing device 20 has a function of fixing, at the nip N2, the toner image transferred (secondary-transferred) onto the paper P by the transfer device 16. The fixing device 20 includes a fixing belt module 100 including a fixing belt 102 as an example of a rotational movement member which rotationally moves and a pressurizing roll 64 as an example of a rotator that comes into contact with an outer surface of the fixing belt 102. The pressurizing roll 64 is an example of a “first rotator” in the present disclosure. The fixing belt 102 is configured with an endless belt. The fixing belt 102 is an example of a “belt” in the present disclosure. The paper P is transported through the nip N2 between the fixing belt 102 and the pressurizing roll 64, so that the toner image on the paper P is fixed by heating and pressurization.

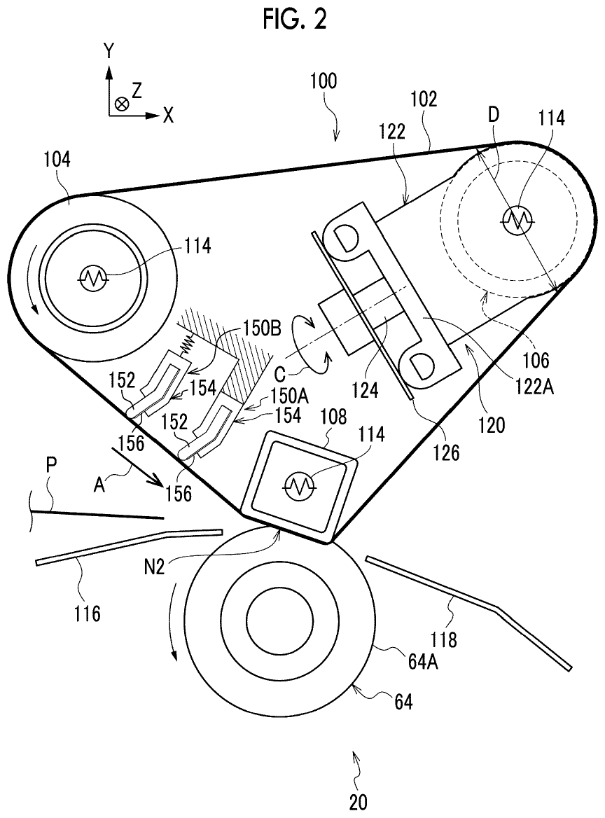

FIG. 2 is a cross-sectional view showing the fixing device 20. As shown in FIG. 2, the fixing device 20 includes the fixing belt module 100 and the pressurizing roll 64 pressed against the fixing belt module 100 as described above. The fixing belt module 100 includes a fixing belt 102 that rotationally moves in the direction of an arrow A, and a stretching roll 104 and a steering roll 106 that stretch the fixing belt 102 from the inside of the fixing belt 102. The fixing belt module 100 is an example of a “belt transport device” in the present disclosure.

In addition, the fixing belt module 100 includes a pressing portion 108 that presses the fixing belt 102 against the pressurizing roll 64 to form the nip N2. The pressing portion 108 is an example of a nip forming portion and is an example of a “pressing member” in the present disclosure. The steering roll 106 is disposed on the upstream side of the stretching roll 104 and on the downstream side of the pressing portion 108 in the rotational movement direction of the fixing belt 102. The stretching roll 104 is an example of a “second rotator” in the present disclosure. In addition, the steering roll 106 is another example of a “second rotator” in the present disclosure.

In addition, the fixing belt module 100 includes a steering mechanism 120 that controls the inclination of the steering roll 106. Further, a first liquid coating device 150A and a second liquid coating device 150B that apply oil as an example of a liquid to the inner surface of the fixing belt 102 are provided between the stretching roll 104 and the pressing portion 108.

The fixing device 20 has a configuration in which a member that comes into contact with the fixing belt 102 is not provided between the steering roll 106 and the stretching roll 104, except for the first liquid coating device 150A and the second liquid coating device 150B. In addition, the fixing device 20 has a configuration in which the member that comes into contact with the fixing belt 102 is not provided between the stretching roll 104 and the pressing portion 108, other than the first liquid coating device 150A and the second liquid coating device 150B. Accordingly, the inner surface of the fixing belt 102 is suppressed from being worn and the other member is suppressed from being deteriorated as compared with a case where the other member that comes into contact with the fixing belt 102 is provided.

In the fixing device 20, the nip N2 is formed by pressing a part of the outer peripheral surface 64A of the pressurizing roll 64 against the outer peripheral surface of the fixing belt 102 that comes into contact with the pressing portion 108 from a side opposite to the pressing portion 108. The nip N2 where the outer peripheral surface 64A of the pressurizing roll 64 and the fixing belt 102 come into contact with each other is a passing portion through which the paper P on which a toner image is formed passes while being pressurized and heated.

The paper P entering the nip N2 has a toner image forming surface on which a toner image is formed, but the paper P enters the nip N2 in a state where the toner image forming surface faces upward in the present exemplary embodiment. Accordingly, a toner image forming surface side of the paper P comes into contact with the fixing belt 102 in the present exemplary embodiment.

In addition, in the present exemplary embodiment, the pressurizing roll 64 is rotationally driven by a motor (not shown), and the fixing belt 102 rotationally moves by following the pressurizing roll 64. That is, the fixing belt 102 receives a driving force from the rotating pressurizing roll 64 and rotationally moves (circulates) in the direction of the arrow A in the drawing.

The stretching roll 104 and the steering roll 106 are rotatably supported, and the fixing belt 102 is wound around the stretching roll 104 and the steering roll 106 at positions separated from each other, whereby the fixing belt 102 is supported to rotatably move. The pressing portion 108 is disposed at a position facing the pressurizing roll 64 with the fixing belt 102 interposed therebetween and presses the fixing belt 102 against the pressurizing roll 64 without rotating. In the present exemplary embodiment, the pressing portion 108 is a rectangular pad. The pressurizing roll 64 includes a layer that can elastically deform to an outer peripheral surface side, and the pressurizing roll 64 is in a shape recessed at the nip N2 as the pressing portion 108 comes into contact therewith via the fixing belt 102. In the present exemplary embodiment, the paper P is interposed from both sides by the pressurizing roll 64 and the pressing portion 108, and a pressure is applied to the paper P.

A heater 114 as an example of a heating member is provided inside the stretching roll 104, the steering roll 106, and the pressing portion 108. The heater 114 is configured with, for example, a halogen heater. The stretching roll 104, the steering roll 106, and the pressing portion 108 are heated by the heat of the heater 114. The fixing belt 102 is heated by heat from the stretching roll 104, the steering roll 106, and the pressing portion 108.

The steering mechanism 120 has a function of displacing the steering roll 106 (that is, changing the inclination). The steering mechanism 120 includes a frame 122 that rotatably supports the steering roll 106 in the circumferential direction, a rotation shaft 124 that rotates the frame 122 in the direction of an arrow C, and a support portion 126 that rotatably supports the rotation shaft 124. Although not shown, the steering mechanism 120 includes a cam that comes into contact with one end portion side of the frame 122 in the width direction, and the one end portion side of the frame 122 in the width direction swings in the direction of an arrow D due to the rotation of the cam. As a result, the inclination of the steering roll 106 is changed. That is, the steering roll 106 is an example of a “second rotator that is displaced in a direction intersecting the rotational movement direction of the belt” in the present disclosure.

The steering roll 106 is inclined with respect to the state in which the stretching roll 104 is parallel by the steering mechanism 120, and accordingly, the fixing belt 102 is moved in the width direction. Accordingly, the position of the fixing belt 102 in the width direction of the steering roll 106 is adjusted, and the positional shift of the fixing belt 102 in the width direction is suppressed.

The fixing device 20 is provided with a first paper guiding member 116 that guides the paper P transported to the nip N2 on the upstream side of the nip N2 in the transport direction of the paper P. The first paper guiding member 116 supports the paper P from below and guides the paper P to the nip N2. In addition, on the downstream side of the nip N2, the fixing device 20 is provided with a second paper guiding member 118 that guides the paper P transported from the nip N2 to the downstream side of the nip N2. The second paper guiding member 118 supports the paper P from below and guides the paper P to the downstream side.

### Liquid Coating Device

Next, the first liquid coating device 150A and the second liquid coating device 150B provided in the fixing device 20 will be described.

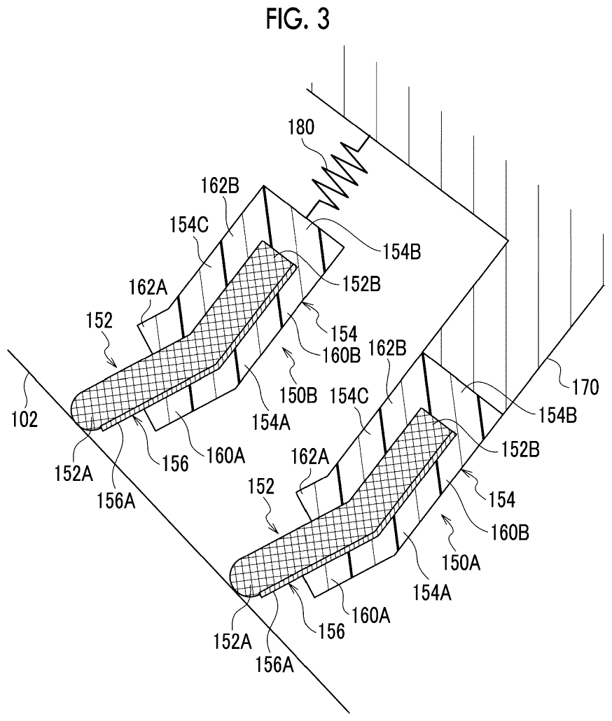

The first liquid coating device 150A is disposed inside the endless fixing belt 102 and has a function of supplying oil to the inner surface of the fixing belt 102. As shown in FIG. 3, the first liquid coating device 150A includes an impregnated member 152 that is impregnated with oil, and a housing 154 that holds the impregnated member 152. Further, the first liquid coating device 150A includes a leaf spring 156 that supports a portion including the end portion 152A side of the impregnated member 152 from the opposite side of the fixing belt 102.

The impregnated member 152 has a plate shape. Then, as shown in FIG. 3, in the impregnated member 152, an end portion 152A along the rotational movement direction of the fixing belt 102 comes into contact with the inner surface of the fixing belt 102. The impregnated member 152 is disposed along a direction (in the present exemplary embodiment, a width direction of the fixing belt 102) intersecting the rotational movement direction of the fixing belt 102. That is, an end portion 152A of the impregnated member 152 in a direction intersecting the longitudinal direction (that is, the width direction) comes into contact with the inner surface of the fixing belt 102. The impregnated member 152 comes into contact with the inner surface of the fixing belt 102 in an oblique direction with respect to the inner surface of the fixing belt 102 in a state of being supported by the housing 154 and the leaf spring 156.

The impregnated member 152 has a configuration in which, for example, oil is impregnated into a nonwoven fabric formed of a fiber having heat resistance. As the fiber having heat resistance, for example, PTFE is used.

The housing 154 is formed in a U-shape in a cross-sectional view shown in FIG. 3, and is disposed to surround a base end portion 152B side opposite to the end portion 152A of the impregnated member 152. The housing 154 is disposed in an oblique direction with respect to the inner surface of the fixing belt 102. The housing 154 includes a plate-shaped rear-side support piece 154A disposed on a side opposite to the fixing belt 102, and an intermediate portion 154B that is bent in a direction perpendicular to the end surface side of the base end portion 152B of the impregnated member 152 from the rear-side support piece 154A. Further, the housing 154 includes a plate-shaped front-side support piece 154C that is bent in a direction perpendicular to the intermediate portion 154B and is disposed on the fixing belt 102 side. The tip end portion 160A of the rear-side support piece 154A is bent in an obtuse angle direction to approach the fixing belt 102 side with respect to the rear end portion 160B. In addition, the tip end portion 162A of the front-side support piece 154C is bent in an obtuse angle direction to approach the fixing belt 102 side with respect to the rear end portion 162B. In the cross-sectional view shown in FIG. 3, the length of the rear-side support piece 154A is longer than the length of the front-side support piece 154C. The housing 154 is attached to a support 170 fixed inside the fixing belt 102. Although not shown in FIG. 2, the support 170 functions as a housing of the fixing device 20. That is, the support 170 also supports the stretching roll 104 and the pressurizing roll 64.

As described above, the leaf spring 156 supports the portion including the end portion 152A side of the impregnated member 152 from the opposite side of the fixing belt 102. Here, the “portion including the end portion 152A side of the impregnated member 152” means that a portion corresponding to the thickness of the impregnated member 152 is supported by the leaf spring 156 with respect to a portion of the end portion 152A of the impregnated member 152 that comes into contact with the fixing belt 102.

The leaf spring 156 is provided on the housing 154 so as to be elastically deformable. The leaf spring 156 has a configuration of pressing the end portion 152A of the impregnated member 152 against the fixing belt 102 by applying a pressure from the opposite side of the fixing belt 102 in a state of being elastically deformed. In the present exemplary embodiment, the leaf spring 156 is configured with a leaf spring disposed along the rotational movement direction of the fixing belt 102 in cross-sectional view. The leaf spring 156 is made of metal.

The first liquid coating device 150A comes into contact with the inner peripheral surface of the fixing belt 102 in a state of being fixed to the support 170 as shown in FIG. 3. As shown in FIG. 3, the first liquid coating device 150A is directly fixed to the support 170. In the present exemplary embodiment, the present invention is not limited to this, and there may be a component that is not easily deformed between the support 170 and the first liquid coating device 150A.

The second liquid coating device 150B has the same configuration as the first liquid coating device 150A as shown in FIGS. 2 and 3. In addition, the second liquid coating device 150B is disposed on the upstream side in the rotation direction of the belt with respect to the first liquid coating device 150A. More specifically, the second liquid coating device 150B comes into contact with the fixing belt 102 between the first liquid coating device 150A and the stretching roll 104. In other words, in the present exemplary embodiment, the position at which the first liquid coating device 150A comes into contact with the fixing belt 102 is closer to the pressing portion 108 than the second liquid coating device 150B.

Here, as shown in FIG. 3, the second liquid coating device 150B is supported by the support 170 via a constant load spring 180. In other words, the second liquid coating device 150B comes into contact with the fixing belt 102 with a constant load. In other words, the second liquid coating device 150B is supported to be capable of following the bending of the fixing belt 102 even in a case where the fixing belt 102 is bent in the thickness direction.

That is, the first liquid coating device 150A and the second liquid coating device 150B are supported by the support 170 in different manners. The thickness direction of the fixing belt 102 is an example of a “direction intersecting the rotational movement direction” in the present disclosure. In the present disclosure, the constant load refers to a range in which the amount of change in the load received by the fixing belt 102 from the first liquid coating device 150A in the amount of displacement of the bending of the fixing belt 102 is negligible in terms of performance.

In the present exemplary embodiment, as shown in FIG. 3, the second liquid coating device 150B can be displaced to linearly move with respect to the fixing belt 102. In addition, in the present exemplary embodiment, it is preferable that the direction in which the second liquid coating device 150B is displaced matches, for example, the thickness direction of the fixing belt 102.

In addition, the second liquid coating device 150B has a function of supplying oil to the inner surface of the fixing belt 102, similarly to the first liquid coating device 150A. The amount of oil included in the impregnated member 152 of the second liquid coating device 150B may be less than that of the first liquid coating device 150A. In other words, the total amount of oil supplied to the fixing belt 102 by the second liquid coating device 150B may be less than that of the first liquid coating device 150A.

Even in a case where the oil included in the impregnated member 152 included in the second liquid coating device 150B is removed, the second liquid coating device 150B continues to come into contact with the fixing belt 102. In this case, the second liquid coating device 150B removes the dust attached to the inner peripheral surface of the fixing belt 102 by the impregnated member. In other words, the second liquid coating device 150B has a function of supplying oil to the inner peripheral surface of the fixing belt 102 and a function of removing the attachment attached to the inner peripheral surface of the fixing belt 102.

In the following description, in a case where the first liquid coating device 150A and the second liquid coating device 150B are not distinguished from each other, both are referred to as “liquid coating device 150”.

### Operation of Image Forming Apparatus

Next, the operation of the image forming apparatus 10 will be described.

The control unit 70 that receives the job data from the external device (not shown) causes the toner image forming unit 14, the transfer device 16, the recording medium transport device 18, and the fixing device 20 to operate. In the toner image forming unit 14, the electrostatic latent image is formed by charging each photoreceptor 22 by each charging device 24 and exposing each photoreceptor 22 by each exposing device 26, and the electrostatic latent image of each photoreceptor 22 is developed as a toner image by each developing device 50. As a result, toner images are respectively formed on the photoreceptors 22. That is, the charging device 24 is an example of a latent image forming device in the present disclosure.

Next, a voltage (a primary transfer voltage) is applied to each transfer roll 32 from a power source (not shown). In addition, the drive roll 38 driven by a drive source (not shown) causes the intermediate transfer belt 30 to rotationally move in the direction along the arrow. As a result, toner images of respective colors are superimposed onto each other and primary-transferred to the intermediate transfer belt 30.

Furthermore, the recording medium transport device 18 feeds the paper P to the nip N1 in accordance with a time at which the toner images of the respective colors held on the rotationally moving intermediate transfer belt 30 reach the nip N1. At the secondary transfer unit 36, a voltage (a secondary transfer voltage) is applied from a power source (not shown) to a power supply roll (not shown) that comes into contact with an outer periphery of the facing roll 56, so that the toner images of the respective colors are secondary-transferred to the paper P passing through the nip N1.

Next, the recording medium transport device 18 feeds the paper P on which the toner images of the respective colors are secondary transferred to the nip N2. As a result, the fixing device 20 fixes the paper P on which the toner images of the respective colors onto the paper P passing through the nip N2, and thus the images are formed on the paper P. Thereafter, the paper P is discharged to a discharge portion 66 by the transport roll 44.

### Operation of Fixing Device

Next, the operation of the fixing device 20 will be described.

In the fixing device 20, the fixing belt 102 is stretched over the stretching roll 104, the steering roll 106, and the pressing portion 108, and the fixing belt 102 rotatably moves in the direction of the arrow A due to the rotation of the pressurizing roll 64. The stretching roll 104, the steering roll 106, and the pressing portion 108 are each provided with a heater 114, and the heater 114 heats the stretching roll 104, the steering roll 106, and the pressing portion 108, thereby heating the fixing belt 102. The paper P on which the toner image is formed is transported through the nip N2 between the fixing belt 102 and the pressurizing roll 64. As a result, the toner image formed on the paper P is melted by heating and pressurization, and the toner image is fixed to the paper P.

In a case where the fixing device 20 is operated, there is a case in which the fixing belt 102 vibrates when the fixing belt 102 rotationally moves. In addition, as a result, there is a case where the locus of the fixing belt 102 is not stable, or the fixing belt 102 rotationally moves in a state of being loosened. In the present description, the state of the fixing belt 102 is referred to as “flapping”.

As described above, in the fixing device 20 in the present exemplary embodiment, the second liquid coating device 150B comes into contact with the fixing belt 102 via the constant load spring 180. Therefore, the second liquid coating device 150B follows the flapping of the fixing belt 102.

### Actions and Effects

Subsequently, the actions and effects of the fixing belt module 100, the fixing device 20, and the image forming apparatus 10 in the present exemplary embodiment will be described.

The fixing belt module 100 according to the aspect includes the pressurizing roll 64 and an endless fixing belt 102 that comes into contact with the pressurizing roll 64 to form a nip N2 and transports the object to be transported with the pressurizing roll 64. In addition, the fixing belt module 100 includes a pressing portion 108 that is provided on the inner peripheral surface of the fixing belt 102 and presses the fixing belt 102 against the pressurizing roll 64 from the inner peripheral surface, and one or more stretching rolls 104 that are provided on the inner peripheral surface side of the fixing belt 102 and stretch the fixing belt 102 together with the pressing portion 108. The plurality of liquid coating devices 150 are provided on the inner peripheral surface of the fixing belt 102 and are disposed side by side in the rotational movement direction of the fixing belt 102 between the pressing portion 108 and the stretching roll 104. In addition, the plurality of liquid coating devices 150 come into contact with the inner peripheral surface of the fixing belt 102 in a state of being supported in different manners by the support 170 that supports the pressing portion 108 and the stretching roll 104.

Therefore, with the fixing belt module 100 according to the aspect, the flapping of the fixing belt 102 may be suppressed as compared with a case where all the liquid coating devices 150 come into contact with the inner peripheral surface of the fixing belt 102 in the fixing belt module 100 in which a plurality of the liquid coating devices 150 are provided in the same manner. That is, according to the fixing belt module 100 according to the aspect, it is possible to stabilize the contact state of the liquid coating device 150 that comes into contact with the fixing belt 102.

In addition, in the fixing belt module 100 according to the aspect, at least one of the plurality of liquid coating devices 150 supplies oil to the inner peripheral surface of the fixing belt 102. Therefore, with the fixing belt module 100 according to the aspect, friction between the fixing belt 102 and the pressing portion 108 may be reduced as compared with a case where all the liquid coating devices 150 come into contact with the inner peripheral surface of the fixing belt 102 in the same manner.

In addition, in the fixing belt module 100 according to the aspect, at least one of the plurality of liquid coating devices 150 removes the attachment attached to the inner peripheral surface of the fixing belt 102. Therefore, with the fixing belt module 100 according to the aspect, friction between the fixing belt 102 and the pressing portion 108 may be reduced as compared with a case where all the liquid coating devices 150 come into contact with the inner peripheral surface of the fixing belt 102 in the same manner. In addition, with the fixing belt module 100 according to the aspect, it is possible to suppress the deterioration of the fixing belt 102 in a case where the attachment attached to the fixing belt 102 enters between the pressing portion 108 and the fixing portion.

In addition, the fixing belt module 100 according to the aspect comes into contact with the inner peripheral surface in a state where the first liquid coating device 150A among the plurality of liquid coating devices 150 is fixed. Therefore, with the fixing belt module 100 according to the aspect, the second liquid coating device 150B stably comes into contact with the inner peripheral surface as compared with a case where all the liquid coating devices 150 comes into contact with the inner peripheral surface of the fixing belt 102 in the same manner.

In addition, in the fixing belt module 100 according to the aspect, the plurality of liquid coating devices 150 are disposed between the pressing portion 108 and the stretching roll 104, and the liquid coating device 150 that comes into contact with the inner peripheral surface in a fixed state is closer to the pressing portion 108 than the second liquid coating device 150B. Therefore, with the fixing belt module 100 according to the aspect, the state of the nip N2 is likely to be stable as compared with a case where the liquid coating device 150 supported by the support 170 in a displaced manner is provided at a position closer to the pressing portion 108.

In addition, in the fixing belt module 100 according to the aspect, the second liquid coating device 150B different from the first liquid coating device 150A is supported to be capable of following the displacement in the rotational movement direction and the thickness direction of the fixing belt 102. Therefore, with the fixing belt module 100 according to the aspect, even in a case where the fixing belt 102 is displaced in the intersection direction, the plurality of liquid coating devices 150 are likely to be maintained in a state of coming into contact with the fixing belt 102.

In addition, in the fixing belt module 100 according to the aspect, the second liquid coating device 150B comes into contact with the inner peripheral surface with a constant load. Therefore, with the fixing belt module 100 according to the aspect, the locus of the fixing belt 102 is likely to be stable as compared with a case where the liquid coating device 150 comes into contact with the inner peripheral surface with a variable load.

In addition, the fixing device 20 according to the aspect includes the fixing belt module 100 and the heater 114, and the pressurizing roll 64 and the fixing belt 102 heat the toner image developed on the paper P and fix the toner image on the paper P at the nip N2. Therefore, with the fixing device 20 according to the aspect, the life of the fixing device 20 is extended as compared with a case where all the liquid coating devices 150 come into contact with the inner peripheral surface of the fixing belt 102 in the fixing device 20 in which a plurality of the liquid coating devices 150 are provided in the same manner.

In addition, the image forming apparatus 10 according to the aspect includes the photoreceptor 22, the charging device 24 that forms a latent image on the surface of the photoreceptor 22, the developing device 50 that develops the latent image into a toner image using toner, the transfer device 16 that transfers the developed toner image onto the paper P, and the fixing device 20 that fixes the toner image on the paper P. Therefore, with the image forming apparatus 10 according to the aspect, the life of the image forming apparatus 10 is extended.

Next, a fixing belt module 200 according to a second exemplary embodiment of the present disclosure will be described. The identical components to the configurations of the first exemplary embodiment described above will be denoted the identical reference numerals and the description thereof will be omitted.

### Second Exemplary Embodiment

### Configuration

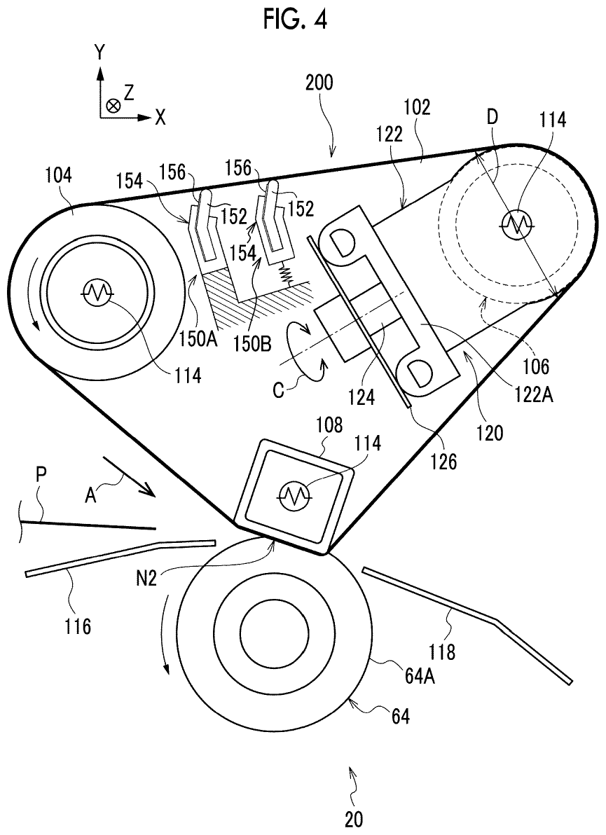

As shown in FIG. 4, in a fixing belt module 200 according to the present exemplary embodiment, a position where the liquid coating device 150 is disposed is different from that of the first exemplary embodiment. More specifically, in the present exemplary embodiment, the liquid coating device 150 is disposed between the stretching roll 104 and the steering roll 106.

In the present exemplary embodiment, the position where the first liquid coating device 150A is disposed is closer to the stretching roll 104 than the position where the second liquid coating device 150B is disposed. In other words, the second liquid coating device 150B comes into contact with the fixing belt 102 at a location where the bending of the fixing belt 102 that is suspended between the stretching roll 104 and the steering roll 106 is likely to be larger than that in the first liquid coating device 150A. More specifically, a distance between a position where the first liquid coating device 150A comes into contact with the fixing belt 102 and the stretching roll 104 is shorter than a distance between a position where the second liquid coating device 150B comes into contact with the fixing belt 102 and the stretching roll 104, and a distance between a position where the second liquid coating device 150B comes into contact with the fixing belt 102 and the steering roll 106.

In other words, in the present exemplary embodiment, the position where the second liquid coating device 150B comes into contact with the fixing belt 102 is closer to the steering roll 106 than the position where the first liquid coating device 150A comes into contact with the fixing belt 102. That is, in the present exemplary embodiment, the second liquid coating device 150B is an example of a “contact member closest to the second rotator that is displaced in a direction intersecting the rotational movement direction of the belt”.

The other configurations are the same as in the first exemplary embodiment.

With the fixing belt module 200 according to the present exemplary embodiment, in addition to the actions and effects of the same configuration as the fixing belt module 100 of the first exemplary embodiment, the following actions and effects are provided.

### Actions and Effects

In the fixing belt module 200 according to the aspect, the first liquid coating device 150A that comes into contact with the inner peripheral surface in a fixed state is closer to the stretching roll 104 than the second liquid coating device 150B. Therefore, with the fixing belt module 200 according to the aspect, the second liquid coating device 150B is more likely to follow the displacement of the fixing belt 102 than in a case where the second liquid coating device 150B is provided at a position closer to the stretching roll 104.

In addition, in the fixing belt module 200 according to the aspect, the steering roll 106 is displaced in a direction intersecting the rotational movement direction of the fixing belt 102. The second liquid coating device 150B, which is the liquid coating device closest to the steering roll 106, follows the displacement in the direction orthogonal to the rotational movement direction of the fixing belt 102. Therefore, in the fixing belt module 200 according to the aspect, even in a case where the steering roll 106 displaces the fixing belt 102 in a direction intersecting the rotational movement direction, a state where the second liquid coating device 150B comes into contact with the fixing belt 102 is likely to be maintained.

### Other Modification Examples

In the above description, the liquid coating device 150 supplies oil to the fixing belt 102. The configuration of the fixing belt module 100 in the present disclosure is not limited thereto, and an aspect may be adopted in which only one liquid coating device 150 supplies oil to the fixing belt 102.

In addition, in the above description, the second liquid coating device 150B has a function of supplying oil to the fixing belt 102 and removing the attachment attached to the fixing belt 102. The configuration of the fixing belt module 100 in the present disclosure is not limited thereto, and an aspect may be adopted in which the second liquid coating device 150B always supplies oil to the fixing belt 102.

In addition, in the above description, the second liquid coating device 150B is supported by the support portion 126 via the constant load spring 180. The configuration of the fixing belt module 100 in the present disclosure is not limited thereto, and for example, an aspect may be adopted in which the second liquid coating device 150B is supported by the support portion 126 via a spring (that is, a normal spring) that outputs a load according to the amount of deformation. In addition, an aspect may be adopted in which the second liquid coating device 150B is driven by a linear motion mechanism such as a slider.

In addition, in the above description, the second liquid coating device 150B can be displaced to linearly move by the constant load spring 180 with respect to the fixing belt 102. The direction in which the second liquid coating device 150B in the present disclosure is displaced is not limited to this, and may be displaced in a swinging manner. More specifically, an aspect may be adopted in which the second liquid coating device 150B is supported by the support 170 through a shaft body that is connected to the support 170 and swings by a torsion spring.

In addition, in the above description, the first liquid coating device 150A comes into contact with the fixing belt 102 in a state of being fixed to the support 170. The configuration of the fixing belt module 100 in the present disclosure is not limited thereto, and an aspect may be adopted in which the first liquid coating device 150A is be driven to follow the displacement of the fixing belt 102.

In addition, in the above description, the first liquid coating device 150A and the second liquid coating device 150B are supported by the fixing belt 102 and the support 170 in different manners. In the present disclosure, the fact that the liquid coating device 150 is supported by the support 170 in a different manner refers to a state in which the liquid coating device 150 is supported such that different loads are applied to the fixing belt 102 in the thickness direction of the fixing belt 102. For example, even in a case where the first liquid coating device 150A and the second liquid coating device 150B are supported by the support 170 via springs having different spring constants, the support is included in the different manner.

In addition, in the fixing belt module 100 of the present disclosure, the first liquid coating device 150A and the second liquid coating device 150B may be supported in the same manner in the depth direction. For example, an aspect may be adopted in which the first liquid coating device 150A and the second liquid coating device 150B are not displaced in the same manner in the depth direction of the fixing belt 102 or are displaced in the same manner.

In addition, in the above description, all the liquid coating devices 150 have the leaf spring 156. The configuration in the present disclosure is not limited thereto, and an aspect may be adopted in which the impregnated member 152 itself has sufficient elasticity. That is, the liquid coating device 150 may not include the leaf spring 156 in the configuration.

In addition, the liquid coating devices 150 of the first exemplary embodiment and the second exemplary embodiment has a configuration in which the oil is applied, but a liquid (for example, water, grease, or the like) other than the oil may be used. For example, it is preferable that the oil or the grease has heat resistance. As an example, a silicone oil, a fluorine-based oil, or the like is used as the oil, and a silicone grease, a fluorine-based grease, or the like is used as the grease.

In addition, in the above description, the liquid coating device 150 is two, that is, the first liquid coating device 150A and the second liquid coating device 150B. The configuration in the present disclosure is not limited thereto, and a large number of liquid coating devices 150 may be further used. In a case where three or more liquid coating devices 150 are provided, it is preferable that the liquid coating device 150 fixed to the support 170 is, for example, one as in the above description. As a result, a state in which the liquid coating device 150 comes into contact with the fixing belt 102 is likely to be maintained as compared with a case where two or more liquid coating devices 150 are fixed to the support 170.

In addition, the configuration of the fixing device in which the liquid coating devices 150 of the first exemplary embodiment and the second exemplary embodiment are used can be changed. In addition, the liquid coating device 150 of the first exemplary embodiment or the second exemplary embodiment may be used for a component of an image forming apparatus other than the fixing device. For example, the liquid coating device 150 of the first exemplary embodiment or the second exemplary embodiment may be used for a transfer belt, a transfer roll, or the like. In a case where the technique of the present disclosure is used for the transfer belt, the toner image transported by the transfer belt corresponds to the transport target in the present disclosure.

Although the exemplary embodiments of the present disclosure have been described above with reference to the accompanying drawings, it is clear that anyone with ordinary knowledge in the field of the art to which the present disclosure belongs can come up with various modifications or applications within the scope of the technical ideas described in the claims, and it is understood that these also naturally belong to the technical scope of the present disclosure.

The aspects of the present disclosure will be further described below.

(((1)))

A belt transport device comprising:
a first rotator;
an endless belt that is formed with a nip portion in contact with the first rotator and that transports an object to be transported by the first rotator while rotationally moving;
a pressing member that is provided on an inner peripheral side of the belt and that forms the nip portion by pressing the belt against the first rotator from the inner peripheral side;
one or more second rotators that are provided on the inner peripheral side of the belt and that stretch the belt together with the pressing member; and
a plurality of contact members that are provided on the inner peripheral side of the belt, that are disposed side by side in a rotational movement direction of the belt between the pressing member and the second rotator or between two of the second rotators, and that come into contact with an inner peripheral surface of the belt in a state of being supported by a support that supports the pressing member and the second rotator in different manners.
   (((2)))

The belt transport device according to ((((1))),
wherein at least one of the plurality of contact members supplies a lubricant to the inner peripheral surface of the belt.
   (((3)))

The belt transport device according to (((1))) or (((2))),
wherein at least one of the plurality of contact members removes an attachment attached to the inner peripheral surface of the belt.
   (((4)))

The belt transport device according to any one of (((1))) to (((3))),
wherein some of the plurality of contact members come into contact with the inner peripheral surface of the belt in a state of being fixed to the support.
   (((5)))

The belt transport device according to (((4))),
wherein the plurality of contact members are disposed between the pressing member and the second rotator, and
a position where a contact member that comes into contact with the inner peripheral surface of the belt in a state of being fixed comes into contact with the inner peripheral surface is closer to the pressing member than a position where another contact member comes into contact with the inner peripheral surface.
   (((6)))

The belt transport device according to (((4))),
wherein a position where a contact member that comes into contact with the inner peripheral surface of the belt in a state of being fixed comes into contact with the inner peripheral surface is closer to the second rotator than a position where another contact member comes into contact with the inner peripheral surface.
   (((7)))

The belt transport device according to (((5))) or (((6))),
wherein the other contact member different from the contact member that comes into contact with the inner peripheral surface of the belt in a state of being fixed is supported to be capable of following displacement in a direction intersecting the rotational movement direction of the belt.
   (((8)))

The belt transport device according to (((7))),
wherein the other contact member comes into contact with the inner peripheral surface with a constant load.
   (((9)))

The belt transport device according to any one of (((1))) to (((4))),
wherein the plurality of contact members are disposed between the two second rotators,
one of the second rotators is displaced in a direction intersecting the rotational movement direction of the belt, and
a contact member that is closest to the second rotator displaced in the direction intersecting the rotational movement direction of the belt among the plurality of contact members is supported to be capable of following the displacement in the direction intersecting the rotational movement direction of the belt.
   (((10)))

A fixing device comprising:
a belt transport device according to any one of (((1))) to (((9))); and
a heating member that heats a recording medium,
wherein the first rotator and the belt fix a toner image developed on the recording medium by heating and pressing.
   (((11)))

An image forming apparatus comprising:
an image carrier;
a latent image forming device that forms a latent image on a surface of the image carrier;
a developing device that develops the latent image into a toner image using a developer;
a transfer device that transfers the toner image developed onto a recording medium; and
the fixing device according to (((10))) that fixes the toner image on the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A belt transport device comprising:
a first rotator;
an endless belt that is formed with a nip portion in contact with the first rotator and that transports an object to be transported by the first rotator while rotationally moving;
a pressing member that is provided on an inner peripheral side of the belt and that forms the nip portion by pressing the belt against the first rotator from the inner peripheral side;
one or more second rotators that are provided on the inner peripheral side of the belt and that stretch the belt together with the pressing member; and
a plurality of contact members that are provided on the inner peripheral side of the belt, that are disposed side by side in a rotational movement direction of the belt between the pressing member and the second rotator or between two of the second rotators, and that come into contact with an inner peripheral surface of the belt in a state of being supported by a support that supports the pressing member and the second rotator in different manners.

2. The belt transport device according to claim 1,
wherein at least one of the plurality of contact members supplies a lubricant to the inner peripheral surface of the belt.

3. The belt transport device according to claim 1,
wherein at least one of the plurality of contact members removes an attachment attached to the inner peripheral surface of the belt.

4. The belt transport device according to claim 1,
wherein some of the plurality of contact members come into contact with the inner peripheral surface of the belt in a state of being fixed to the support.

5. The belt transport device according to claim 4,
wherein the plurality of contact members are disposed between the pressing member and the second rotator, and
a position where a contact member that comes into contact with the inner peripheral surface of the belt in a state of being fixed comes into contact with the inner peripheral surface is closer to the pressing member than a position where another contact member comes into contact with the inner peripheral surface.

6. The belt transport device according to claim 4,
wherein a position where a contact member that comes into contact with the inner peripheral surface of the belt in a state of being fixed comes into contact with the inner peripheral surface is closer to the second rotator than a position where another contact member comes into contact with the inner peripheral surface.

7. The belt transport device according to claim 5,
wherein the other contact member different from the contact member that comes into contact with the inner peripheral surface of the belt in a state of being fixed is supported to be capable of following displacement in a direction intersecting the rotational movement direction of the belt.

8. The belt transport device according to claim 6,
wherein the other contact member different from the contact member that comes into contact with the inner peripheral surface of the belt in a state of being fixed is supported to be capable of following displacement in a direction intersecting the rotational movement direction of the belt.

9. The belt transport device according to claim 7,
wherein the other contact member comes into contact with the inner peripheral surface with a constant load.

10. The belt transport device according to claim 8,
wherein the other contact member comes into contact with the inner peripheral surface with a constant load.

11. The belt transport device according to claim 1,
wherein the plurality of contact members are disposed between the two second rotators,
one of the second rotators is displaced in a direction intersecting the rotational movement direction of the belt, and
a contact member that is closest to the second rotator displaced in the direction intersecting the rotational movement direction of the belt among the plurality of contact members is supported to be capable of following the displacement in the direction intersecting the rotational movement direction of the belt.

12. The belt transport device according to claim 2,
wherein the plurality of contact members are disposed between the two second rotators,
one of the second rotators is displaced in a direction intersecting the rotational movement direction of the belt, and
a contact member that is closest to the second rotator displaced in the direction intersecting the rotational movement direction of the belt among the plurality of contact members is supported to be capable of following the displacement in the direction intersecting the rotational movement direction of the belt.

13. The belt transport device according to claim 3,
wherein the plurality of contact members are disposed between the two second rotators,
one of the second rotators is displaced in a direction intersecting the rotational movement direction of the belt, and
a contact member that is closest to the second rotator displaced in the direction intersecting the rotational movement direction of the belt among the plurality of contact members is supported to be capable of following the displacement in the direction intersecting the rotational movement direction of the belt.

14. The belt transport device according to claim 4,
wherein the plurality of contact members are disposed between the two second rotators,
one of the second rotators is displaced in a direction intersecting the rotational movement direction of the belt, and
a contact member that is closest to the second rotator displaced in the direction intersecting the rotational movement direction of the belt among the plurality of contact members is supported to be capable of following the displacement in the direction intersecting the rotational movement direction of the belt.

15. A fixing device comprising:
a belt transport device according to claim 1; and
a heating member that heats a recording medium,
wherein the first rotator and the belt fix a toner image developed on the recording medium by heating and pressing.

16. An image forming apparatus comprising:
an image carrier;
a latent image forming device that forms a latent image on a surface of the image carrier;
a developing device that develops the latent image into a toner image using a developer;
a transfer device that transfers the toner image developed onto a recording medium; and
the fixing device according to claim 15 that fixes the toner image on the recording medium.
